(19) United States
(12) Patent Application Publication
(10) Pub. No.: US 2024/0224887 A9
(43) Pub. Date: Jul. 11, 2024

(54) TRELLIS SYSTEM AND APPARATUS, DRYING SYSTEM AND APPARATUS, COMBINATION TRELLIS SYSTEM AND DRYING SYSTEM, AND METHODS OF USE THEREOF

(71) Applicant: Robert David LEVY, JR., Madison, MS (US)

(72) Inventor: Robert David LEVY, JR., Madison, MS (US)

(21) Appl. No.: 18/489,335

(22) Filed: Oct. 18, 2023

Related U.S. Application Data
(60) Provisional application No. 63/380,134, filed on Oct. 19, 2022.

(51) Int. Cl. A01G 9/12; A01F 25/12

(52) U.S. Cl. CPC A01G 9/12; A01F 25/12

(57) ABSTRACT

A trellis including a first frame to be removeably connected to one or more support posts, the first frame configured to have first plurality of support rods removeably connected thereto in a first orientation and a second plurality of support rods removeably connected thereto in a second orientation. The trellis may include a second frame to be removeably connected to the one or more support posts, the second frame configured to have a third plurality of support rods removeably connected thereto in a third orientation and a fourth plurality of support rods removeably connected thereto in a fourth orientation.

### CROSS-REFERENCE TO RELATED APPLICATION

This application claims priority to U.S. Provisional Application No. 63/380,134, titled: TRELLIS SYSTEM, APPARATUS, AND METHODS OF USE THEREOF, filed on Oct. 19, 2022, the entirety of which is incorporated by reference herein for all purposes.

### INTRODUCTION

The present disclosure generally relates to a system, apparatus, and method for supporting plants during a growth cycle, particularly the trellising of plants.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Therefore, unless otherwise indicated herein, what is described in this section is not prior art to the description and claims in this application and is not admitted to be prior art by inclusion in this section.

As a result of research, the scientific community and consumers alike have recognized the advantages of products that are more natural and a market for medication, food, and other consumables that are natural has developed. One such natural product is cannabis and hemp. As to the medical and homeopathic industry, for example, cannabidiol (CBD) may be used to improve various ailments without the harsh side effects resulting from many other treatments. Further, the scientific community has recognized that cannabis and cannabis derivatives are effective for managing pain and other treatable medical conditions. In addition, states and countries have legalized cannabis for recreational use. Thus, cannabis, hemp, and cannabis-derived compounds have become more and more popular, which is resulting in growth and expansion of the cannabis and hemp industry. While cannabis and hemp farms all over the world are incorporating new technology and innovations to advance the production process to new levels there is still a large opportunity for improvements to be made in the efficiency of growing and harvesting cannabis and hemp.

Successfully growing cannabis and hemp is tedious and requires daily upkeep and a significant amount of manual labor. For example, trellis netting is commonly installed early in the growth cycle of cannabis and hemp plants. As the plants mature, additional trellis netting is frequently added to support the plants and prevent breakage as plant flowers develop. To harvest the plants, the trellis netting must be cut away and removed. This cutting away and removal of the trellis netting is not only tedious but is also wasteful. For example, trellis netting frequently becomes entangled in the foliage of the plants and is thus tedious and difficult to remove. Further, because the netting is entangled in the foliage, oftentimes employees who are removing the trellis netting damage the plants or remove beneficial substances that naturally occur on the plants. In addition, trellis netting is generally not reusable, which results in increased waste. Thus, there is an unmet need for a more efficient and less wasteful trellising system and method.

### SUMMARY

The following presents a simplified summary of one or more aspects of the invention in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description that is presented later.

In one aspect of the disclosure, a trellis system for supporting one or more plants is disclosed. The trellis system may include a plurality of support posts configured to extend in a substantially vertical orientation and a first frame removeably connected to the one or more support posts. The first frame is configured to have first plurality of support rods removeably connected thereto in a first orientation and a second plurality of support rods removeably connected thereto in a second orientation. The system further includes a second frame removeably connected to the one or more support posts. The second frame is configured to have a third plurality of support rods removeably connected thereto in a third orientation and a fourth plurality of support rods removeably connected thereto in a fourth orientation. Further, at least one of the first frame and second frame or the plurality of support posts may include a plurality of connection interfaces for removeably connecting the first frame and second frame to the plurality of support posts.

In some aspects of the disclosure, a method of growing a plurality of plants in a substantially vertical direction is disclosed. The method of growing may include installing a plurality of support posts configured to extend in a substantially vertical orientation; installing a first frame to the plurality of support posts so that the first frame extends in a plane that is substantially horizontal and extends substantially perpendicular to the plurality of support posts; installing a first plurality of support rods to the first frame along a first orientation; and installing a second plurality of support rods to the first frame along a second orientation. After the plants have grown in height, a third plurality of support rods and a fourth plurality of support rods may be installed on a second frame that is positioned higher on the support posts than the first frame. The third plurality of support rods may be installed in third positional orientation and the fourth plurality of support rods may be installed in a fourth positional orientation. As the plants grow, additional frames and/or support rods may be added to provide additional support to the plants. Once the plants are ready for harvesting, the first plurality of support rods, second plurality of support rods, third plurality of support rods, fourth plurality of support rods, and any additional support rods may be removed to allow access to the plants for harvesting.

In some aspects, a trellis apparatus to supporting a plurality of plants is disclosed. The trellis apparatus includes a frame that may be configured to be connected to a plurality of support posts so that the frame extends in a plane that is substantially horizontal and extends substantially perpendicular to the plurality of support posts, and wherein the frame is configured to have first plurality of support rods removeably connected thereto in a first orientation and a second plurality of support rods removeably connected thereto in a second orientation. The trellis apparatus further includes a first plurality of rods configured to be removeably connected to the frame in the first orientation; and a second plurality of rods configured to be removeably connected to the frame in the second orientation.

These and other aspects of the invention will become more fully understood upon a review of the detailed description, which follows.

### BRIEF DESCRIPTION OF THE DRAWINGS

FIG. 1 shows an example of a trellis system according to aspects of the disclosure.

FIGS. 2-4 show examples of the trellis system in various use orientations at stages of plant growth and cultivation.

FIG. 5 shows a close-up partial view of a first type of interface usable with aspects of the disclosure.

FIG. 6 shows a close-up partial view of a second type of interface usable with aspects of the disclosure.

FIG. 7 shows a close-up partial view of a third type of interface usable with aspects of the disclosure.

FIG. 8A shows a close-up view of one example of a connection interface.

FIG. 8B shows another example of an interface usable with the disclosure.

FIGS. 9A, 9B, and 9C, show a top, first side, and second side view of one portion of a frame member usable with the disclosure.

FIGS. 10A, 10B, and 10C, show a top, first side, and second side view of a second portion of a frame member usable with the disclosure.

FIG. 11 shows an example of a drying system according to aspects of the disclosure.

FIG. 12 shows an example of a system with multiple drying apparatuses according to aspects of the disclosure.

FIG. 13 shows a close-up partial view of a first type of interface usable with aspects of the disclosure.

FIG. 14 shows a close-up partial view of a second type of interface usable with aspects of the disclosure.

FIG. 15 shows a close-up partial view of a third type of interface usable with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in simplified form in order to avoid obscuring such concepts.

### I. Terminology

Throughout the disclosure, the terms substantially or approximately may be used as a modifier for a geometric relationship between elements or for the shape of an element or component. While the terms substantially or approximately are not limited to a specific variation and may cover any variation that is understood by one of ordinary skill in the art to be an acceptable variation, some examples are provided as follows. In one example, the term substantially or approximately may include a variation of less than 10% of the dimension of the object or component. In another example, the term substantially or approximately may include a variation of less than 5% of the object or component. If the term substantially or approximately is used to define the angular relationship of one element to another element, one non-limiting example of the term substantially or approximately may include a variation of 5 degrees or less. These examples are not intended to be limiting and may be increased or decreased based on the understanding of acceptable limits to one of skill in the relevant art.

For purposes of the disclosure, directional terms are expressed generally with relation to a standard frame of reference when the system and apparatus described herein is installed in an in-use orientation. Further, in order to provide context to the current disclosure, a broad overview of the discovered deficiencies of various systems and an example implementation of the current disclosure and the advantages provided by the disclosure are described below. Further details of example implementations of the current disclosure are described in detail with reference to the figures below.

Terms such as a, an, and the are not intended to refer to only a singular entity, but include the general class of which a specific example may be used for illustration. The terms a, an, and the may be used interchangeably with the term at least one. The phrases at least one of and comprises at least one of followed by a list refers to any one of the items in the list and any combination of two or more items in the list. All numerical ranges are inclusive of their endpoints and non-integral values between the endpoints unless otherwise stated.

The terms first, second, third, and fourth, among other numeric values, may be used in this disclosure. It will be understood that, unless otherwise noted, those terms are used in their relative sense only. In particular, in some aspects certain components may be present in interchangeable and/or identical multiples (e.g., pairs). For these components, the designation of first, second, third, and/or fourth may be applied to the components merely as a matter of convenience in the description of one or more of the aspects of the disclosure.

As used herein, the terms plant or plants is not limited to any particular species of plant and can also include fungi, including mushrooms.

As used herein, the term rod or rods may be used in this disclosure. The term rod or rods may for example include any one or combination of an elongated rigid or semi-rigid structure that is capable of supporting plants. The term rod or rods is not intended to limit the cross-sectional area or shape of the elongated structures. However, some non-limiting examples of a cross-sectional profile of a rod may include any one or a combination of a round, circular, oval, square, rectangular, star-shaped, or any polygon or shape with curved sides.

Aspects of the disclosure and the advantages the disclosure provides are described throughout this disclosure. The detailed examples that follow have been presented for purposes of illustration and description. It is not intended to be exhaustive nor to limit the disclosure to the forms described. Numerous modifications are possible in light of the above teachings, including a combination of the abovementioned aspects. Some of those modifications have been discussed and others will be understood by those skilled in the art. The various aspects were chosen and described in order to best illustrate the principles of the present disclosure and various aspects as are suited to the particular use contemplated. The scope of the present disclosure is, of course, not limited to the examples or aspects set forth herein, but can be employed in any number of applications and equivalent devices by those of ordinary skill in the art. Rather, it is hereby intended the scope be defined by the claims appended hereto.

### II. Detailed Examples

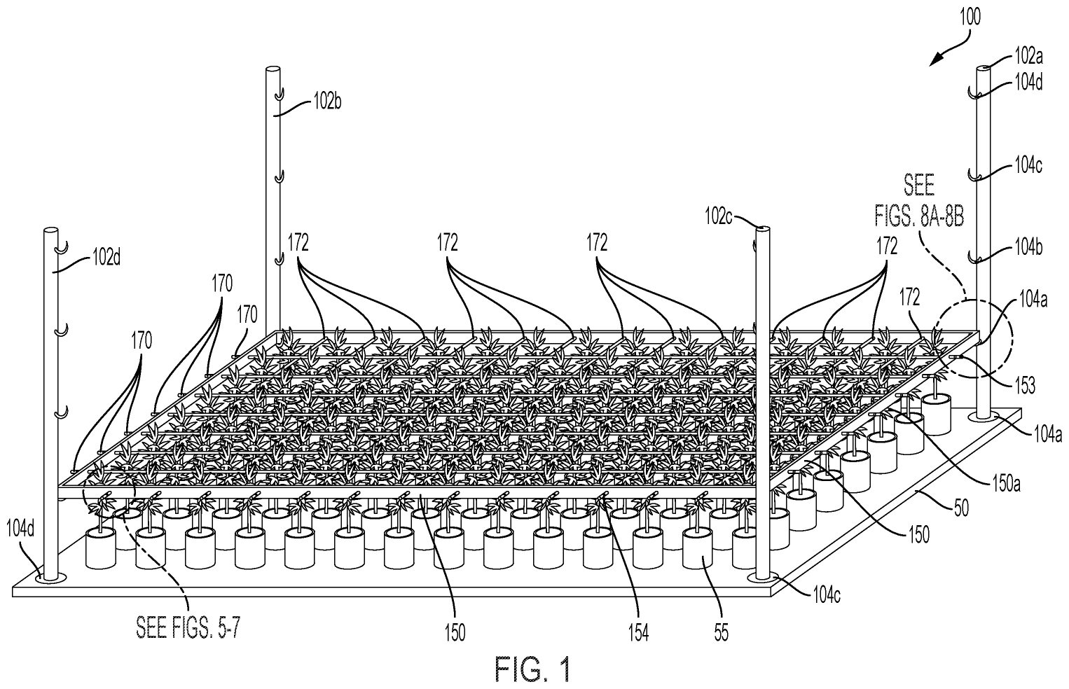

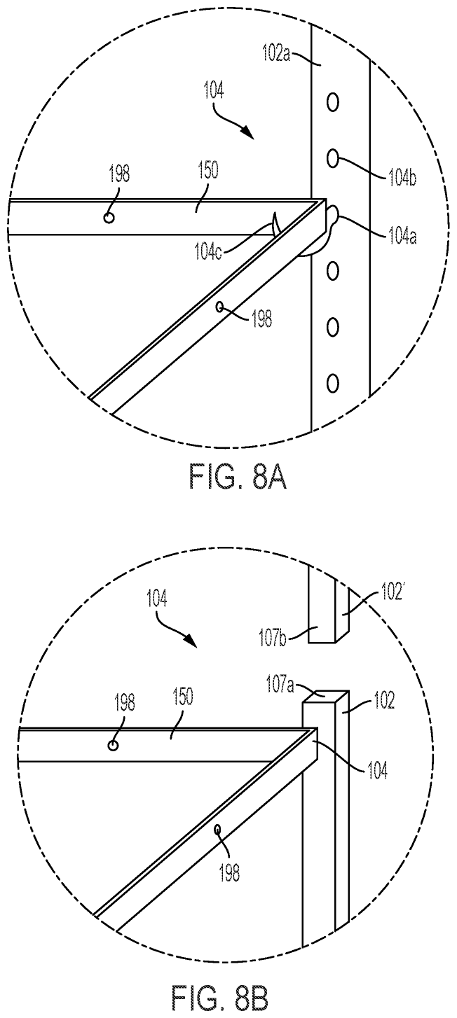

FIG. 1 shows one example of a trellis system 100 and apparatus according to aspects of the disclosure. The trellis system and apparatus 100 may for example be usable with a growing table or surface 50. The growing table or surface 50 may for example have a plurality of support members (e.g., support posts 102a-102d) set on or mounted thereto via support post mounts 104a-d (104b associated with 102b is hidden from view in FIG. 1). As shown in FIG. 1, each of the support posts 102a-102d may extend in a substantially vertical direction when mounted to or placed on a substantially horizontal growing table or surface 50. It is noted that while in the Figures, four support posts 102a-102d are shown, any number of support posts may be implemented. For example, the system may instead utilize a single support post or structure, two supports, three supports, five supports, six supports or eight supports. In one example the system may utilize any number of support structures or posts less than thirty. Further it is noted that while the support posts 102a-102d are shown mounted to or set on a growing table or surface 50, any one, combination, or all of the support posts may instead be mounted from a ceiling and/or wall of a larger structure. Further, while elongated posts are shown, the support posts 102a-102d may be substituted with a frame or support structure such as a rectangular, square, or triangulated support structure, for example. Further, as described with respect to FIG. 8B below, each one of the support posts 102a-102d may be formed of a plurality of post segments that are configured to interlock or otherwise connect to one another end-to-end.

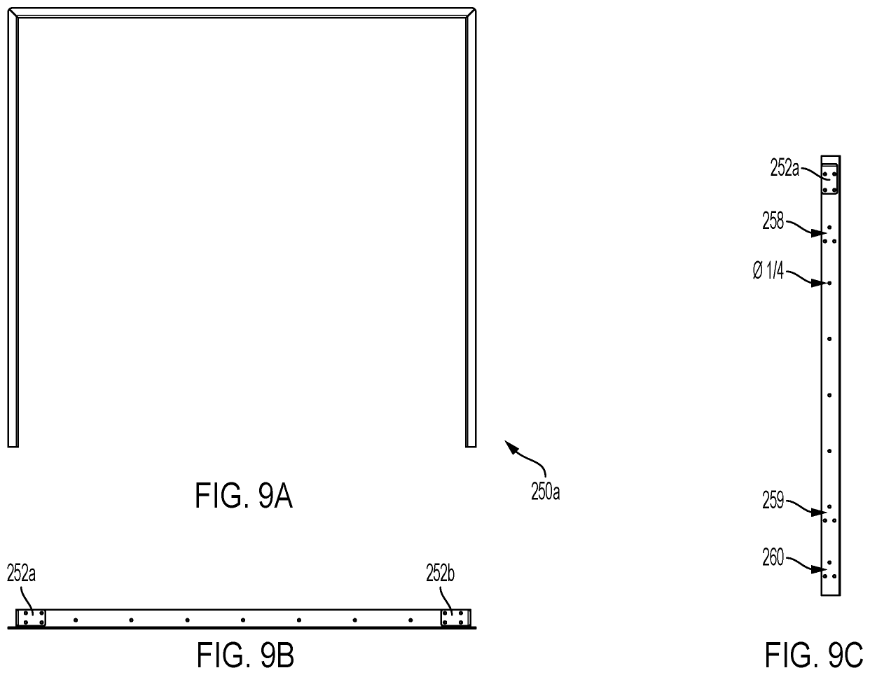

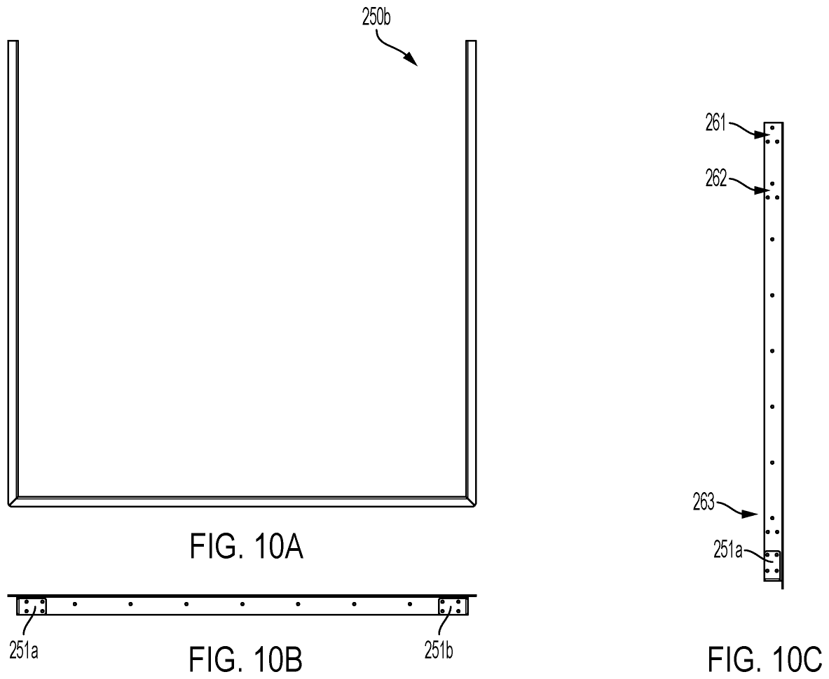

The support posts 102a-102d may be configured to have removeably or permanently mounted thereto a frame 150. The frame 150 may for example be square or rectangular and may include one or more sets of frame members 150a and/or 150b. The frame 150 may be removeably mounted to the support posts 102a-102d so as to fall within a plane is substantially horizontal. For example, the one or more frame members 150a and/or 150b may extend along a line that is substantially perpendicular to the support posts 102a-102d. As described in further detail below, the frame 150 may for example be assembled by connecting three or more frame members to form a first frame portion (e.g., reference 250a in FIG. 9A) with three sides of a square or rectangle and connecting a second set of three or more frame members to form a second frame portion (e.g., reference 250b in FIG. 10A) with three sides of a square or rectangle to one another to form a rectangular frame. In some aspects, the first frame portion 250a and second frame portion 250b may be selectively connectable via bolts or other fasteners to allow the overall length and/or width of the frame to be adjustable based on user needs (e.g., the number of plants that will be grown).

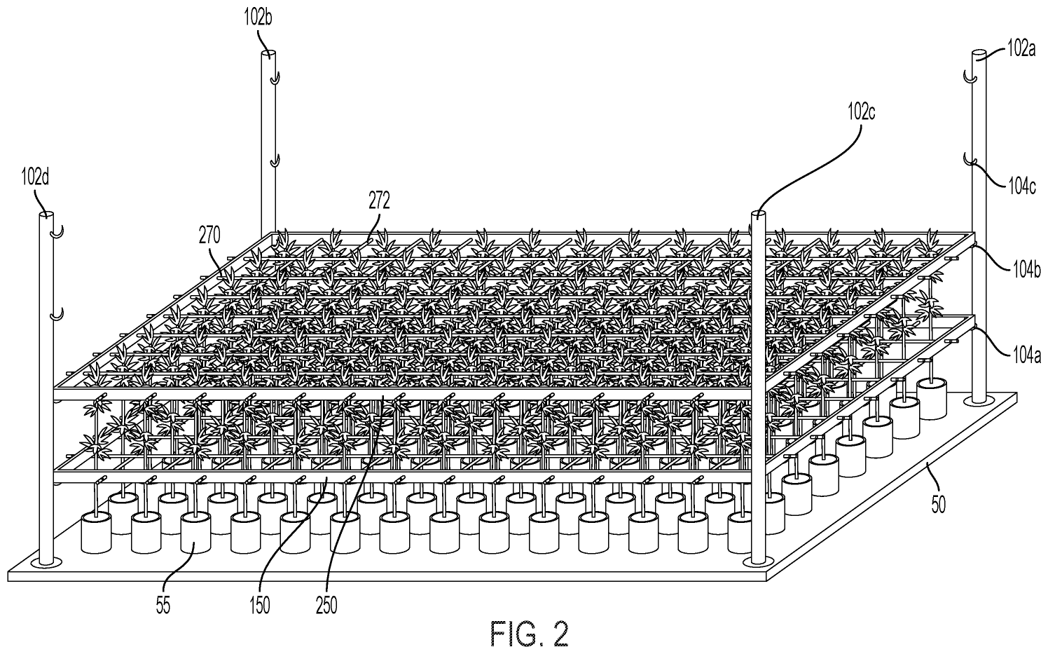

Each one of the posts or support structures 102a-102d may for example have a number of connection interfaces 104a-104d. The aforementioned support structures or posts may for formed of a rigid or semi-rigid material. In some examples, the posts or support structures may be formed of steel or any alloy. In some examples, the posts or support structures may be formed of stainless steel or aluminum which allow the posts or support structure to be robust while preventing corrosion. Stainless steel or aluminum, especially stainless steel may allow the post or support structure to be easily cleaned and/or otherwise disinfected for example. Similarly, forming the post or support structure out of aluminum may prevent corrosion while allowing for easy cleaning or disinfection of the posts or support structure. In some examples, the posts or support structure may be formed of a rigid plastic, semi-rigid plastic, fiberglass, or composite material. In some examples, the posts or support structure may be formed of a non-conductive material. It is noted that while only the example connection interfaces of post 102a are labeled in FIG. 1, posts 102b, 102c, and 102d may include similar interfaces. In one example the interfaces may include evenly spaced holes or through holes that are configured to receive or have threaded or passed therethrough any one or combination of a nut, bolt, pin, or threaded fastener. The through holes may also be configured to receive a hook-shaped receiving member as shown in FIGS. 1-4. Additional details of the connection interface(s) 104a-104d are described in further detail below with respect to FIGS. 8 and 9. The interfaces 104a-104d are configured to engage with the frame 150 and thus allow a user to place or otherwise mount frame 150 to the posts 102a-102d. Further, by providing a number of evenly spaced connection interface(s) 104a-104d, a user may adjust the height of the frame 150 with respect to the growing table or surface 50 and/or may add additional frames as described in further detail below with respect to FIGS. 2-4.

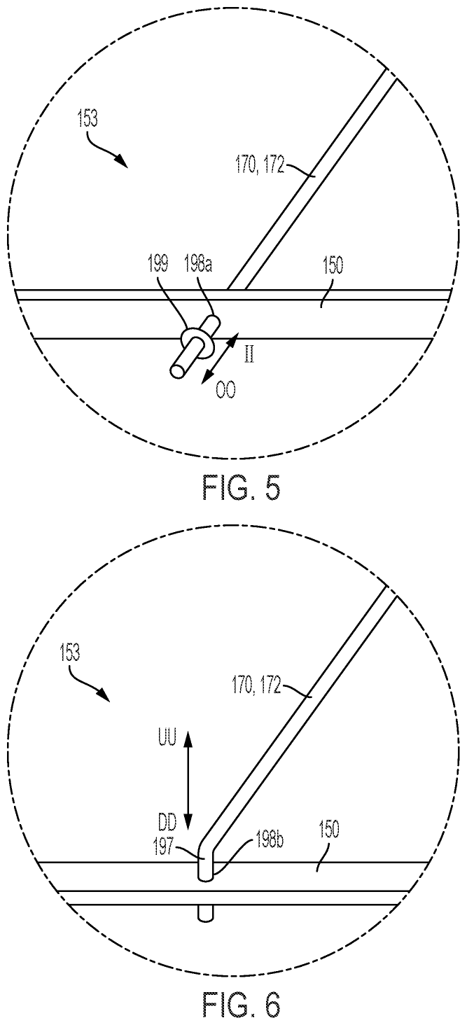

The frame 150 may be configured to have a first plurality of support rods 172 removeably connected thereto in a first orientation and a second plurality of support rods 170 connected thereto in a second orientation. As shown in FIG. 1, the first orientation may be perpendicular to or substantially perpendicular to the second orientation so that a grid-pattern is formed within the frame 150 when any one, any combination or, or all of the first plurality of support rods 172 and second set of support rods 170 are connected to the frame 150. The first plurality of support rods 172 and second plurality of support rods 170 may be removeably connected to the frame 150 via respective receiving portions 153 that are configured to support each one of the plurality of rods at a first and second end thereof. The interaction between the engaging portion and the first and second ends of the rods may be configured to allow a user to easily install and/or remove each rod while minimizing contact with the plants 55. For example, the interface between the frame 150 and each one of the plurality of rods (e.g., rods 170 and 172) may be configured to allow a user to place or otherwise set each rod onto the frame at specific intervals. Once each rod of the plurality (e.g., rods 170 and 172) is placed or otherwise set into the respective interface of the frame 150, the rod may be supported by the frame 150 and removeably constrained by the interface so that the rod remains in place with respect to the frame 150. In another example, each rod of the plurality of rods (e.g., rods 170 and 172) may be slid into each respective interface of the frame 150 so that the rod is removeably constrained by the interface 153 and supported by the frame 150. The aforementioned examples are not intended to be limiting—the interface 153 between the rods and/or frame may include any configuration that allows the removable support each rod with respect to the frame so that the support rods can support one or more of the plurality of plants 55. Additional examples of connection interface(s) and rod configurations are described in further detail with respect to FIGS. 5-7 below. The frames mentioned throughout this disclosure may for formed of a rigid or semi-rigid material. In some examples, the frame may be formed of stainless steel or aluminum which allow the frame to be robust while preventing corrosion. Stainless steel or aluminum, especially stainless steel may allow the frames to be easily cleaned and/or otherwise disinfected for example. Similarly, forming the frames out of aluminum may prevent corrosion while allowing for easy cleaning or disinfection of the frames. In some examples, the frames may be formed of a rigid plastic, semi-rigid plastic, fiberglass, or composite material. In some examples, the frames may be formed of a non-conductive material.

FIGS. 2-4 show examples of the trellis system 100 in various use orientations at stages of plant growth and cultivation. It is noted that while the trellis system may include various features that are identical to or similar to the features shown in FIG. 1, reference numbers have been omitted to prevent obscuring of the figures. FIG. 2 shows a trellis system in a second use orientation with posts 102a-102d and the first frame 150 and corresponding support rods (e.g., support rods 170 and 172 in FIG. 1) already installed as described above with respect to FIG. 1. After plants 55 grow taller as shown in FIG. 2, a user may install a second frame 250 to the posts 102a-102d at a second connection interface 104b that is higher on the post 102a than the first connection interface 104a. It is noted that while connection interfaces are not labeled with reference to posts 102c-102d, similar or identical connection interfaces to connection interfaces 104a-104d may be provided at each of the posts 102c-102d. Once the second frame 250 is installed, a series of support rods, similar to the first support rods 172 and second support rods 170 (one of each of which is labeled with reference label 272 and 270, respectively) may be installed onto the second frame 250. The support rods 272 may be interchangeably referred to throughout the disclosure as a third plurality of support rods or third support rods and the support rods 270 may be interchangeably referred to throughout the disclosure as a fourth plurality of support rods or fourth support rods. The second frame may include similar or identical connection interfaces as described above with respect to FIG. 1 and as described below with respect to FIGS. 5-7. Once the second frame and third support rods 272 and fourth support rods 270 are installed, the now more mature and/or taller plants 55 can be supported by the grid formed by the first plurality of support rods 172, second plurality of support rods 170, third plurality of support rods 272, and fourth plurality of support rods 270.

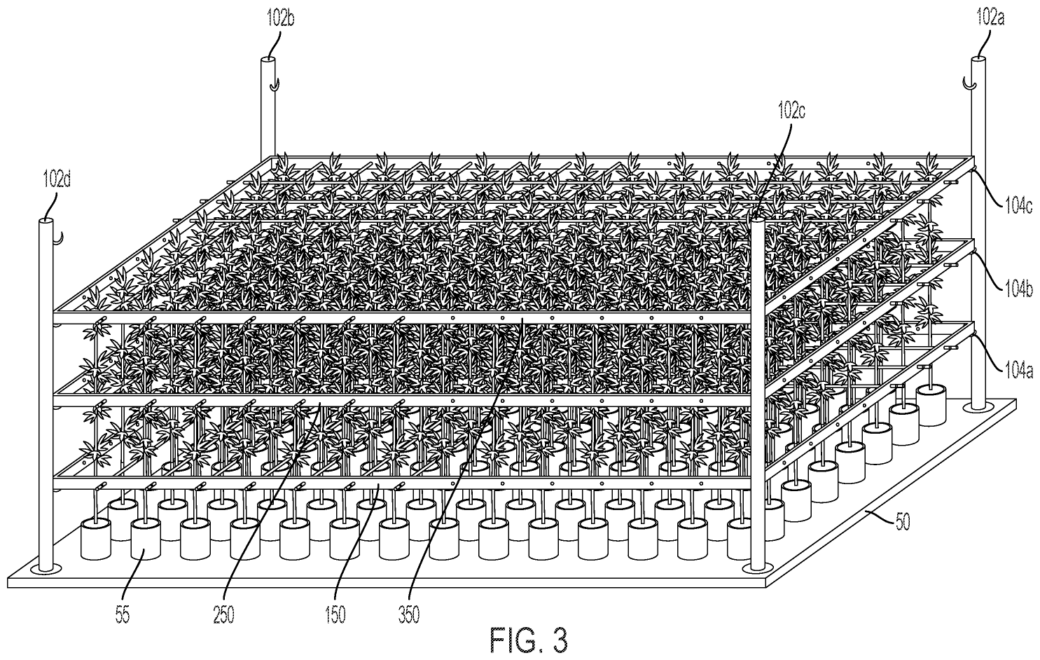

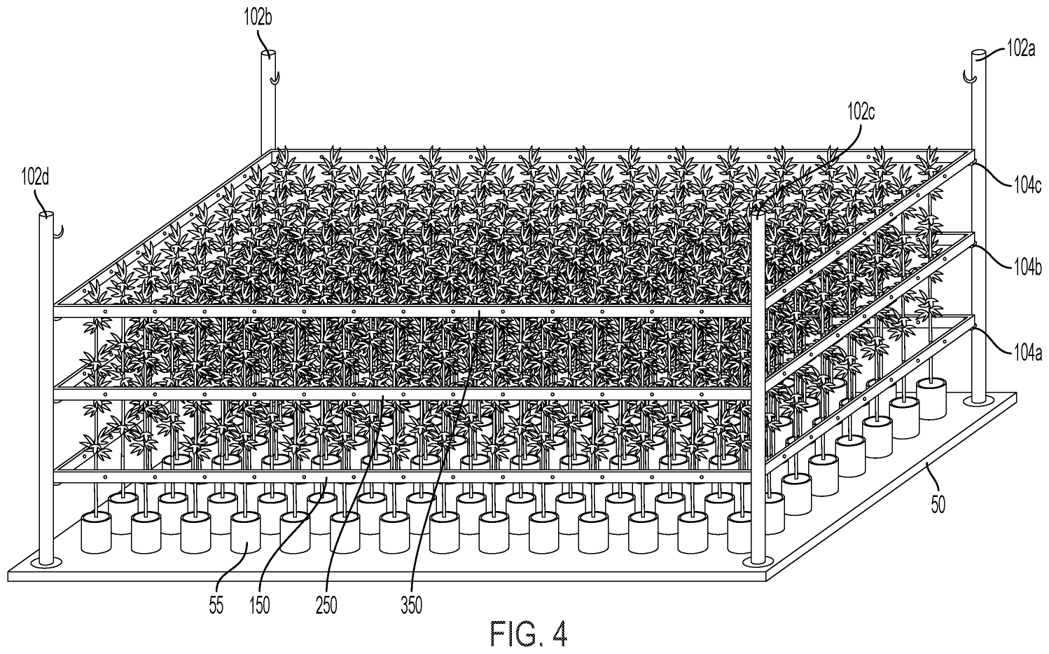

As shown in FIG. 3, if additional support is needed for the plants 55, a third frame 350 may be added and corresponding support rods may be installed, a process similar to that described above with respect to FIGS. 1 and 2. Further, while not shown in the figures additional frames may be added for plants that require additional support during the growth cycle. For example, a fourth, fifth, six, or even seventh frame may be added to provide for additional support. FIGS. 3 and 4 show examples of the support rods partially removed (FIG. 3) and all removed (FIG. 4).

When the plants 55 are ready for harvesting, a user or users may remove the aforementioned support rods. In some examples, each of the support rods may be removed from a respective frame by either one or a combination of a sliding movement and/or a lifting movement to disengage or remove each rod from a respective interface (e.g., interface 153 in FIG. 1). The support rods may be removed thus freeing the plants (and foliage thereof) from the support rods. The rigid structure of each rod and/or the interface for installing/removing each rod from a respective frame provide significant advantages over netting or non-rigid trellis supports. For example, trellis netting, string, or cables frequently becomes entangled in the foliage of the plants and are thus tedious and difficult to remove, especially right before harvesting of the plants. Further, because the netting, string, or cables may become entangled in the foliage, oftentimes employees who are removing the trellis damage the plants or remove beneficial substances that naturally occur on the plants. The aspects described herein allow users to easily and more efficiently remove the support structure to free up the plants for harvesting and eliminates waste associated with netting or other non-rigid trellises that require cutting and disposal of nets, cables, or ropes. In one example method, the support rods may be cleaned, disinfected, high-level disinfected, or sanitized and may be re-used. For example, once a group of plants is harvested, the aforementioned frames may be removed and may be cleaned, disinfected, high-level disinfected or sanitized and new plants or seedlings may be placed on the growing table and/or surface 50 and the aforementioned processes may be repeated for a new crop of plants while re-using the trellis system and components described herein. The aforementioned aspects also allow for easy cleaning, disinfecting, high-level disinfecting, and/or sanitizing of the frames and/or support rods. Properly cleaning the support structure ensures that plants are not contaminated or otherwise subject to unwanted foreign objects or substances, which may provide additional advantages in crop yields and ensures that the plants are not unnecessarily contaminated by the support structure.

FIG. 5 shows a close-up partial view of a first type of interface 153 usable with aspects of the disclosure. For example any one or combination of the support rods 170, 172, 270 and/or 272 may for example be configured to be slideably received in a first opening 198a and a second opening (hidden from view) of the frame 150. The support rod (e.g., 170, 172) may for example further include a stopper 199 which prevents the support rod from sliding past opening 198a when it is installed into the frame 150 (e.g., when slid into the frame 150 in direction II). The stopper 199 may additionally assist a user with quickly and efficiently installing and/or removing the support rod from the frame by providing a stopping point so that a user can quickly slide each rod into the frame 150. The rod (e.g., 170, 172) can be slid out of the frame in direction OO, for example when removing the support rods for harvesting as described above.

FIG. 6 shows a close-up partial view of a second type of interface 153 usable with aspects of the disclosure. The second type of interface differs from the first type of interface described above in that the first opening 198b, and optionally the second opening (hidden from view) faces upward/downward (e.g., has a central axis which may extend substantially vertically for example). Either one of or both ends of the rod (e.g., 170, 172) may have a bent or angled portion 197 configured to be received in the opening 198b. In this example, the rod (e.g., 170, 172) may be installed in direction DD and removed by lifting the rod in direction UU. This second type of interface may for example be useful when the trellis system 100 is used in an environment that has limited space, which may prevent a user from being able to slide-out each rod as in the first type of interface described above with respect to FIG. 5.

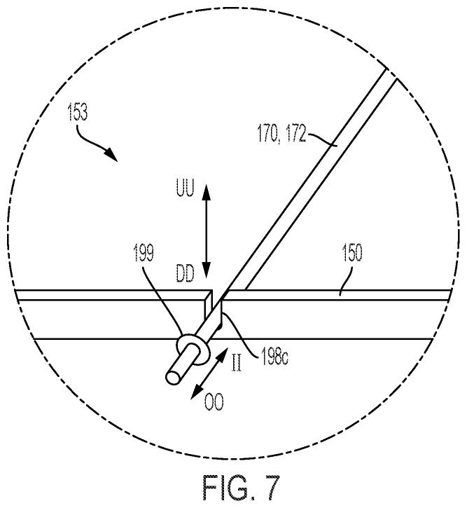

FIG. 7 shows a close-up partial view of a third type of interface 153 usable with aspects of the disclosure. For example, any one or combination of the support rods 170, 172, 270 and/or 272 may for example be configured to be slideably received (e.g., in direction II) or set into (e.g., in direction DD) a first opening 198c and a second opening (hidden from view) of the frame 150. The support rod (e.g., 170, 172) may for example further include a stopper 199 which prevents the support rod from sliding past opening 198a when it is installed into the frame 150 (e.g., when slid into the frame 150 in direction II). The stopper 199 may additionally assist a user with quickly and efficiently installing and/or removing the support rod from the frame by providing a stopping point so that a user can quickly slide and/or set each rod into the frame 150. The rod (e.g., 170, 172) can be slid out of the frame in direction OO and/or lifted out of the frame in direction UU, This third type of interface may for example be useful when the trellis system 100 is used in an environment that has limited space, which may prevent a user from being able to slide-out each rod as in the first type of interface described above with respect to FIG. 5. Further, the third type of interface may provide additional efficiency because the U-shaped or otherwise concave shaped opening 198c guides the rod (e.g., 170, 172) into the opening, thus allowing a user to more quickly install and/or remove the rods from the frame.

It is noted that the aforementioned examples are not intended to be limiting and additional may be used in combination with one another. For example, a trellis system may use the interface of FIG. 5 (without the stopper 199) at one end of a rod/frame and the interface of FIG. 6 at a second end of a rod/frame. Likewise, a trellis system may use the interface of FIG. 7 at a first end of a rod/frame and the interface of FIG. 6 at a second end of the rod/frame. In another example, the trellis system may use the interface of FIG. 5 (without the stopper 199) at a first end of the rod/frame and the interface of FIG. 7 at a second end of the rod/frame.

The aforementioned rods (e.g., 170, 172) may for formed of a rigid or semi-rigid material. In some examples, the rods may be formed of stainless steel or aluminum which allow the rods to be robust while preventing corrosion. Stainless steel or aluminum, especially stainless steel may allow the rods to be easily cleaned and/or otherwise disinfected for example. Similarly, forming the rods out of aluminum may prevent corrosion while allowing for easy cleaning or disinfection of the rods. In some examples, the rods may be formed of a rigid plastic, semi-rigid plastic, fiberglass, or composite material. In some examples, the rods may be formed of a non-conductive material.

FIGS. 8A and 8B show different examples of a post/frame connection interface usable with aspects of the disclosure. For example, each one of the posts or support structures 102a-102d (FIGS. 1-4) may for example have a number of connection interfaces 104a-104d (FIG. 1). FIG. 8A shows a close-up view of one example of a connection interface at post 102a. It is noted that while only the example connection interfaces of post 102a are labeled in FIG. 1, posts 102b, 102c, and 102d may include similar interfaces. In one example the interfaces may include evenly spaced holes (104a, 104b) or through holes that are configured to receive or have threaded or passed therethrough any one or combination of a nut, bolt, pin, or threaded fastener. The through holes may also be configured to receive a hook-shaped receiving member 104c as additionally shown in FIGS. 1-4. The hooks may be removeable from the through holes 104a and/or 104b. In another example not shown, the frame 150 may be tied or wired to the post 102a and/or may be directly bolted, screwed, or otherwise fastened to the support post 102a. In some examples, the frame 104 may be connected to existing posts (i.e., when retrofitted to posts or other support structures that are already mounted) using known methods. In the example shown in FIG. 8A, the evenly spaced through holes (e.g., 104a, 104b) allow a user to place or otherwise mount frame 150 at various heights with respect to the growing table or surface 50 and/or allow a user to add additional frames as described in further detail above.

FIG. 8B shows another example of an interface usable with the disclosure. In the example in FIG. 8B, the post 102a may for example be segmented. In some examples, the segments (e.g., segment 102, 102′) may be removeably connected to or permanently connected to each frame 150. Each segment may for example have an interface (e.g., first interface 107a) that is configured to engage with or otherwise connect to another segment (e.g., second interface 107b). For example, the first interface 107a may be configured to receive or otherwise have fit-within it the second interface 107b. Thus, as the plants grow, a second frame (e.g., with segment 102′ connected thereto) is “stacked” onto the first frame, which allows for a modular trellis system that does not require excessively long posts to be mounted to or otherwise placed on a growing table or surface 50. It is noted that while FIG. 8B shows a close-up view of one example of a connection interface at post 102a. posts 102b, 102c, and 102d (FIGS. 1-4) may include similar interfaces, in which case the posts 102a-102d would not extend from the growing table or surface 50 as shown in FIGS. 1-4.

FIGS. 9A, 9B, and 9C, show a top, first side, and second side view of one portion of a frame member usable with the disclosure. It is noted that while example dimensions are given, the current disclosure is not limited to the dimensions shown. Further, the dimension shown in FIG. 9B can vary by ±1.5 inches, the dimension in FIG. 9A can vary by ±30 inches for example.

FIGS. 10A, 10B, and 10C, show a top, first side, and second side view of a second portion of a frame member usable with the disclosure. It is noted that while example dimensions are given, the current disclosure is not limited to the dimensions shown. Further, in one example the dimension shown in 10A can vary by ±30 inches for example. FIGS. 9A-10C show examples of a first portion 250a and a second portion 250b of a frame that is adjustable in a dimension. In some examples, the frame shown in FIGS. 9A-10C may share features with or may be analogous with the frame 150, 250, and/or 350 described above. The frame 150, 250, and/or 350 may for example be comprised of the first portion 250a, which includes 3-sides of a square or rectangle. The three sides may for example be connected via one or more right-angle or substantially 90-degree brackets 252a. The first portion 250a may be connected or otherwise fastened to the second portion 250b. Similarly, the second portion 250b may include 3-sides of a square or rectangle. The three sides may for example be connected via one or more right-angle or substantially 90-degree brackets 251a. Similarly, the first and second portions 250a and/or 250b may connect to one another via a series of connection portions 258, 259, 260, 261, 262, or 263. For example, the connection portions may be through holes configured to receive bolts or other fasteners to join the first portion 250a to the second portion 250b to form a square or rectangular frame. By altering the connection point between the first portion 250a and 250b, a user may adjust a dimension of the frame (i.e., may make the frame shorter or longer in width and/or length). The aforementioned aspects are advantageous for altering the size of each frame for use with a different number of plants or sizes of crops, for example. Further, removing the bolts and/or other fasteners that join the first portion 250a to the second portion 250b may for example allow a user to separate the two portions of the frame, which may make it easier to remove the frame when the plants are ready for harvesting. In another example, removal of the first portion 250a from the second portion 250b may for example (or separating the individual sides of the frames may allow for easier storage or shipping of the frame(s).

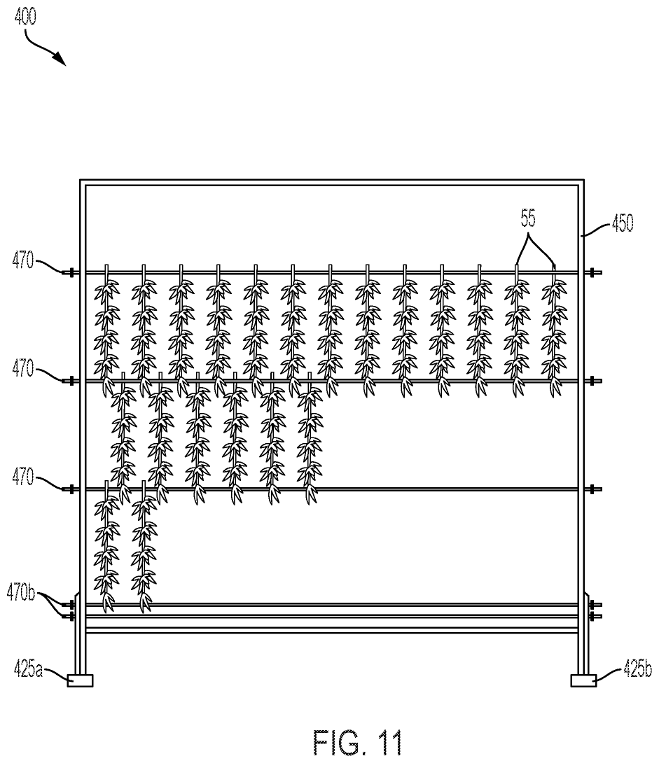

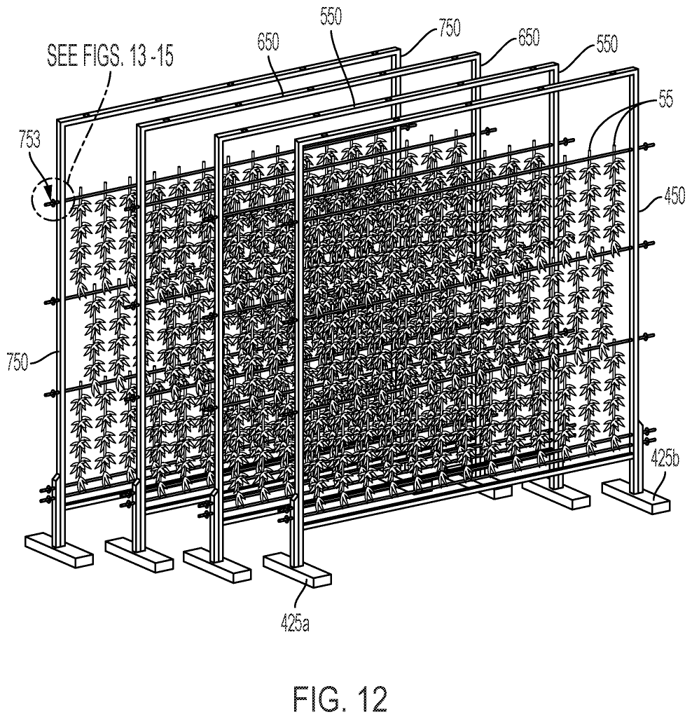

FIGS. 11 and 12 show examples of a drying system 400 and apparatus according to aspects of the disclosure. In some examples, the drying system and apparatus 400 may share any one or combination of features with and/or may be analogous with the trellis system and apparatus described above with respect to FIGS. 1-10C. For example, the drying system may include any one or combination of the frame members described above (e.g., frame members 150, 250, and/or 350) and/or the support rods (e.g., 170, 172, 270, and/or 272). In one example, the frame(s) (e.g., 150, 250, and/or 350) may be oriented vertically instead of horizontally to have plants 55 (FIGS. 11 and 12) hung on one or more of the support rods (e.g., 170, 172, 270, and/or 272) for drying plants after harvest, for example. In the example described above, the same frame(s) may be used for both supporting the plants while they grow and for drying plants after harvest, thus decreasing the costs of equipment and/or simplifying and decreasing the amount of equipment needed for growing and harvesting plants. Accordingly, one aspect of the disclosure combines features described herein into a combination trellis and drying system and method. In other aspects, the drying system 400 may differ from the trellis system described above. For example, the support rods may be spaced further from one another than the examples described above and/or the materials or configuration of the two systems may vary.

As shown in FIG. 11, the drying system 400 may have a frame 450. The drying system may include two or more supports 425a and/or 425b that stabilize or otherwise support the frame 450 to remain in a substantially vertical orientation with respect to the ground or other support surface. In one example, the two or more supports may be analogous with or share features with segment 102 and/or segment 102′ described above with respect to FIG. 8b. In other example, the two or more supports 425a and/or 425b may be removably mounted to the frame 450 by passing and/or sliding one or more support rods thorough openings in the frame 450 and the two or more supports 425a and/or 425b. In another example, the two or more supports 425a and/or 425b may be mounted to the frame 450 via one or more fasteners or bolts or may be permanently attached (e.g., via welding or gluing) to the frame 450.

it is noted that while in the Figures, two supports are shown, any number of supports may be implemented. For example, the system may instead utilize a single support structure, three supports, four supports, five supports, six supports, or eight supports. In one example the system may utilize any number of support structures less than thirty. Further it is noted that while the supports are shown mounted to the bottom of the frame 450, any one, combination, or all of the support posts may instead be mounted from a ceiling and/or wall of a larger structure. Further, while T-shaped support structures are shown, the support structures may be substituted with a frame or support structure such as a rectangular, square, or triangulated support structure.

The frame 450 may for example be square or rectangular and may include one or more sets of frame members (e.g., 250a and/or 150b in FIGS. 9A-10C). The frame 150 may be removeably mounted to the supports described above so as to fall within a plane is substantially vertical. As described in further detail above, the frame 450 may for example be assembled by connecting three or more frame members to form a first frame portion (e.g., reference 250a in FIG. 9A) with three sides of a square or rectangle and connecting a second set of three or more frame members to form a second frame portion (e.g., reference 250b in FIG. 10A) with three sides of a square or rectangle to one another to form a rectangular frame. In some aspects of the disclosure, the first frame portion 250a and second frame portion 250b may be selectively connectable via bolts or other fasteners to allow the overall length and/or width of the frame to be adjustable based on user needs (e.g., the number of plants that will be dried and/or the needed dimensions of the drying rack(s)).

The aforementioned support structures or frame may for formed of a rigid or semi-rigid material. In some examples, the support structures and/or frame may be formed of steel or any alloy. In some examples, the support structures and/or frames may be formed of stainless steel or aluminum which allow the s support structure and/or frame to be robust while preventing corrosion. Stainless steel or aluminum, especially stainless steel may allow structure to be easily cleaned and/or otherwise disinfected. In some examples, the structure may be formed of a rigid plastic, semi-rigid plastic, fiberglass, or composite material. In some examples, the structure may be formed of a non-conductive material.

The frame 450 may be configured to have a first plurality of support rods 470 removeably connected thereto in a first orientation. As shown in FIG. 11, the first orientation be substantially perpendicular or otherwise perpendicular to an imaginary line that falls within a plane of the support surface or ground beneath the first plurality of support rods 470. The plurality of support rods 470 may be removeably connected to the frame 450 via respective receiving portions that are configured to support each one of the plurality of rods 470 at a first and second ends thereof. The interaction between the engaging portion and the first and second ends of the rods may be configured to allow a user to easily install and/or remove each rod while minimizing contact with the plants 55. For example, the interface between the frame 450 and each one of the plurality of the support rods 470 may be configured to allow a user to place or otherwise set each rod onto the frame at specific intervals. Once each rod of the plurality of rods is placed or otherwise set into the respective interface of the frame 450, the rod may be supported by the frame 450 and removeably constrained by the interface so that the rod remains in place with respect to the frame 450.

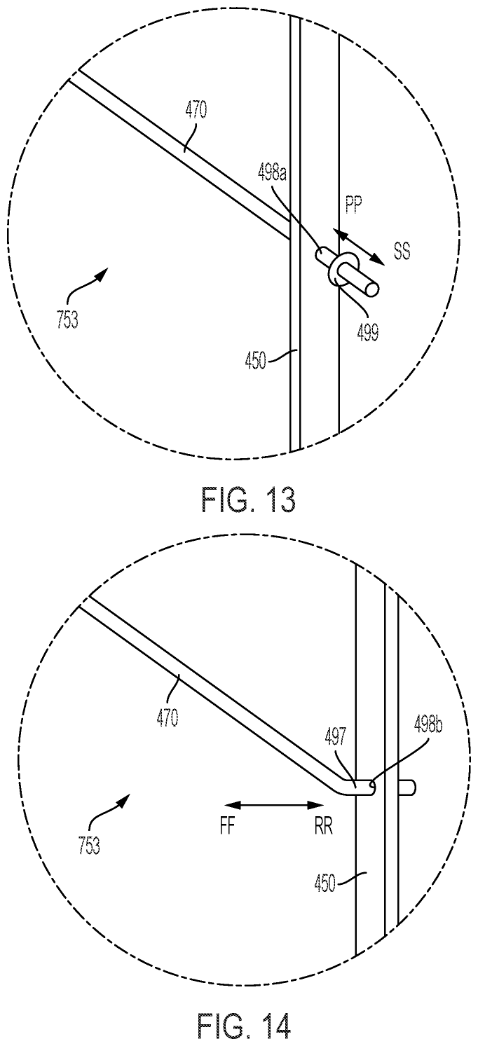

In another example, each rod of the plurality of rods 470 may be slid into each respective interface of the frame 450 so that the rod is removeably constrained by the interface 753 (FIG. 12) and supported by the frame 450. The aforementioned examples are not intended to be limiting—the interface 753 between the rods and/or frame may include any configuration that allows the removable support each rod with respect to the frame so that the support rods can support one or more of the plurality of plants 55. Additional examples of connection interface(s) and rod configurations are described in further detail with respect to FIGS. 13-15 below. The frames mentioned throughout this disclosure may for formed of a rigid or semi-rigid material. In some examples, the frame may be formed of stainless steel or aluminum which allow the frame to be robust while preventing corrosion. Stainless steel or aluminum, especially stainless steel may allow the frames to be easily cleaned and/or otherwise disinfected for example. Similarly, forming the frames out of aluminum may prevent corrosion while allowing for easy cleaning or disinfection of the frames. In some examples, the frames may be formed of a rigid plastic, semi-rigid plastic, fiberglass, or composite material. In some examples, the frames may be formed of a non-conductive material.

FIG. 12 shows an example of a plurality of drying systems in use orientations at stages for drying multiple plants 55. It is noted that while the drying system may include various features that are identical to or similar to the features shown in FIG. 11, reference numbers have been omitted to prevent obscuring of the figures. FIG. 12 shows multiple frames 450, 550, 750 and/or 750 being utilized to dry multiple plants 55. It is noted that while connection interfaces are not labeled with reference to frames 450, 550 and/or 650, similar or identical connection interfaces may be provided to support each of the frame(s).

As shown in FIG. 12, plants 55 may be hung from each of the plurality of support rods 470 and the support rods may be installed at any height of the frame 450 allowing for the drying of plants 55 of different sizes and lengths.

In one example, the plants 55 may have been harvested after growing via the methods described above, and the plants 55 may be hung to dry on each of the support rods. Once the plants 55 are sufficiently dried, a user or users may remove the plants 55 by pulling them off the plurality of support rods 470 and/or the aforementioned support rods may be removed allowing the plants 55 to fall therefrom, which in some cases may increase the speed and efficiency of removing the dried plants 55 from the drying system.

In some examples, each of the support rods may be removed from a respective frame by either one or a combination of a sliding movement and/or a lifting movement to disengage or remove each rod from a respective interface (e.g, interface 753 in FIG. 12). The support rods may be removed thus freeing the dried or partially dried plants (and foliage thereof) from the support rods. The rigid structure of each rod and/or the interface for installing/removing each rod from a respective frame provide significant advantages over netting or non-rigid drying supports. For example, netting, string, or cables frequently become entangled in the foliage of the plants and are thus tedious and difficult to remove, especially from delicate dried plants. Further, because the netting, string, or cables may become entangled in the foliage, oftentimes employees who are removing the trellis damage the plants or remove beneficial substances that naturally occur on the plants. The aspects described herein allow users to easily and more efficiently remove the support structure to free up the plants for further processing and eliminates waste associated with netting or other non-rigid trellises that require cutting and disposal of nets, cables, or ropes. In one example method, the support rods may be cleaned, disinfected, high-level disinfected, or sanitized and may be re-used. For example, once a group of plants dried and/or harvested and/dried in examples where the same system is used for both supporting plants during the lifecycle and for drying thereafter, the aforementioned frames may be removed and may be cleaned, disinfected, high-level disinfected or sanitized to prepare for the growing and/or drying of new plants. The aforementioned aspects also allow for easy cleaning, disinfecting, high-level disinfecting, and/or sanitizing of the frames and/or support rods. Properly cleaning the support structure ensures that plants are not contaminated or otherwise subject to unwanted foreign objects or substances, which may provide additional advantages in crop yields and ensures that the plants are not unnecessarily contaminated by the support structure.

FIG. 13 shows a close-up partial view of a first type of interface 753 usable with aspects of the disclosure. For example, any one or combination of the support rods 470 may for example be configured to be slideably received in a first opening 498a and a second opening (hidden from view) of the frame 450. The support rod 470 may for example further include a stopper 499 which prevents the support rod from sliding past opening 498a when it is installed into the frame 450 (e.g., when slid into the frame 450 in direction PP). The stopper 499 may additionally assist a user with quickly and efficiently installing and/or removing the support rod from the frame by providing a stopping point so that a user can quickly slide each rod into the frame 450. The rod 470 can be slid out of the frame in direction SS, for example when removing the support rods when drying is complete as described above.

FIG. 14 shows a close-up partial view of a second type of interface 753 usable with aspects of the disclosure. The second type of interface differs from the first type of interface described above in that the first opening 498b, and optionally the second opening (hidden from view) faces forward/backward (e.g., has a central axis which may extend substantially horizontally for example). Either one of or both ends of the rod may have a bent or angled portion 497 configured to be received in the opening 498b. In this example, the rod 470 may be installed in direction RR and removed in direction FF. This second type of interface may for example be useful when the drying system is used in an environment that has limited space, which may prevent a user from being able to slide-out each rod as in the first type of interface described above with respect to FIG. 13.

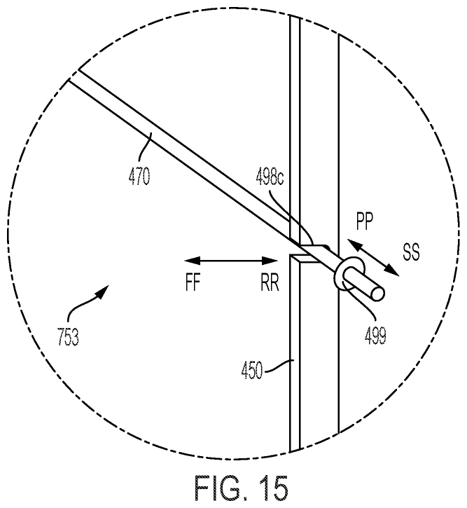

FIG. 15 shows a close-up partial view of a third type of interface 753 usable with aspects of the disclosure. For example, any one or combination of the support rods 470 may for example be configured to be slideably received (e.g., in direction SS) or set into (e.g., in direction RR) a first opening 498c and a second opening (hidden from view) of the frame 4470. In one example, the first and/or second opening may be slot-shaped and may either angle slightly downward and/or may have a rear portion that is a decreased distance from the bottom of the frame 450 than a front portion. The aforementioned configuration may prevent the plurality of support rods 470 from unintentionally sliding out of the first opening 498c in direction FF. The support rod 470 may for example further include a stopper 499 which prevents the support rod from sliding past opening 498c when it is installed into the frame 450 (e.g., when slid into the frame 450 in direction PP). The stopper 499 may additionally assist a user with quickly and efficiently installing and/or removing the support rod from the frame by providing a stopping point so that a user can quickly slide and/or set each rod into the frame 450. The rod 470 can be slid out of the frame in direction SS and/or lifted out of the frame in direction FF, This third type of interface may for example be useful drying system 400 is used in an environment that has limited space. Further, the third type of interface may provide additional efficiency because the U-shaped or otherwise concave shaped opening 498c guides the rod 470 into the opening, thus allowing a user to more quickly install and/or remove the rods from the frame.

It is noted that the aforementioned examples are not intended to be limiting and additional may be used in combination with one another. For example, a drying system may use the interface of FIG. 13 without the stopper at one end of a rod/frame and the interface of FIG. 14 at a second end of a rod/frame. Likewise, a drying system may use the interface of FIG. 15 at a first end of a rod/frame and the interface of FIG. 14 at a second end of the rod/frame. In another example, the trellis system may use the interface of FIG. 13 (without the stopper) at a first end of the rod/frame and the interface of FIG. 15 at a second end of the rod/frame.

The aforementioned rods 450 may for formed of a rigid or semi-rigid material. In some examples, the rods may be formed of stainless steel or aluminum which allow the rods to be robust while preventing corrosion. Stainless steel or aluminum, especially stainless steel may allow the rods to be easily cleaned and/or otherwise disinfected for example. Similarly, forming the rods out of aluminum may prevent corrosion while allowing for easy cleaning or disinfection of the rods. In some examples, the rods may be formed of a rigid plastic, semi-rigid plastic, fiberglass, or composite material. In some examples, the rods may be formed of a non-conductive material.

This written description uses examples to disclose aspects of the invention, including the preferred embodiments, and also to enable any person skilled in the art to practice the aspects thereof, including making and using any devices or systems and performing any incorporated methods. The patentable scope of these aspects is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

What is claimed is:

1. A trellis system for supporting one or more plants comprising:
a plurality of support posts configured to extend in a substantially vertical orientation;
a first frame removeably connected to the one or more support posts, the first frame configured to have first plurality of support rods removeably connected thereto in a first orientation and a second plurality of support rods removeably connected thereto in a second orientation;
a second frame removeably connected to the one or more support posts, the second frame configured to have a third plurality of support rods removeably connected thereto in a third orientation and a fourth plurality of support rods removeably connected thereto in a fourth orientation; and
wherein at least one of the first frame and second frame or the plurality of support posts have a connection interface for removeably connecting the first frame and second frame to the plurality of support posts.

2. The trellis system of claim 1, wherein the first plurality of rods, second plurality of rods, third plurality of rods, and fourth plurality of rods are substantially identical.

3. The trellis system of claim 1, wherein the first orientation and the third orientation are substantially parallel, and the second orientation and fourth orientation are substantially parallel.

4. The trellis system of claim 1, wherein the first orientation is substantially perpendicular to the second orientation and the and third orientation is substantially perpendicular to the fourth orientation.

5. The trellis system of claim 1 further comprising a third frame removeably connected to the one or more support posts, the third frame configured to have a fifth plurality of support rods removeably connected thereto in a fifth orientation and a sixth plurality of support rods removeably connected thereto in a sixth orientation that is substantially perpendicular to the fifth orientation, wherein the first plurality of rods, second plurality of rods, third plurality of rods, fourth plurality, fifth plurality of rods and sixth plurality of rods are substantially identical.

6. The trellis system of claim 1, wherein the first frame is configured to be connected to the one plurality of support posts at a first post position and the second frame is configured to be connected to the plurality of posts at a second post position that is different from the first position, and wherein the first frame extends along a first plane and the second frame extends along a second plane that is parallel with the first plane, wherein both the first plane and the second plane are substantially horizontal.

7. The trellis system of claim 1, wherein the first plurality of support rods are configured to be removeably received at a first rod end and at a second rod end opposite the first rod via a first series of receiving portions on the first frame and wherein the second plurality of rods are configured to be removeably received at a first rod and end and at second rod end opposite the first rod end via a second series of receiving portions on the first frame.

8. The trellis system of claim 7, wherein the first frame has a first set of frame members and a second set of frame members, wherein the first set of frame members are connected to the second set of frame members to form a substantially rectangular shape, and wherein the first series of receiving portions comprise a plurality of openings at substantially even intervals along the first set of frame members and the second series of receiving portions comprise a plurality of openings at substantially even intervals along the second set of frame members.

9. The trellis system of claim 1, wherein the first plurality of rods, second plurality of rods, third plurality of rods, and fourth plurality of rods comprise at least one of a bent end portion or a stopper.

10. The trellis system of claim 1, wherein the first plurality of rods, second plurality of rods, third plurality of rods, and fourth plurality of rods have a substantially circular cross-sectional shape.

11. A method of growing a plurality of plants in a substantially vertical direction, the method comprising:
installing a plurality of support posts configured to extend in a substantially vertical orientation;
installing a first frame to the plurality of support posts so that the first frame extends in a plane that is substantially horizontal and extends substantially perpendicular to the plurality of support posts;
installing a first plurality of support rods to the first frame along a first orientation; and
installing a second plurality of support rods to the first frame along a second orientation.

12. The method of claim 11, wherein installing the first plurality of support rods comprises sliding each of the first plurality of support rods through a respective first one of a first series of openings in the first frame and through a second one of the first series of openings in the first frame so that a first end and a second end opposite the first end of each of the plurality of support rods is supported by the first frame, and
wherein installing the second plurality of support rods comprises sliding each of the second plurality of rods through a respective third one of a second series of openings in the first frame and through a fourth one of the second series of openings in the first frame so that a first end and a second end opposite the first end of each of the second plurality of support rods is supported by the first frame.

13. The method of claim 11, wherein installing the first plurality of support rods comprises engaging each of the first plurality of support rods with a respective first one of a first series of openings in the first frame and with a second one of the first series of openings in the first frame so that a first end and a second end opposite the first end of each of the plurality of support rods is supported by the first frame, and
wherein installing the second plurality of support rods comprises engaging each of the second plurality of rods with a respective first one of a second series of openings in the first frame and a through a second one of the second series of openings in the first frame so that a first end and a second end opposite the first end of each of the second plurality of support rods is supported by the first frame.

14. The method of claim 11, further comprising:
removing the first plurality of support rods from the first frame;
removing the second plurality of support rods from the first frame; and
harvesting the plurality of plants.

15. The method of claim 14, wherein the first frame is removed from the plurality of support rods before harvesting the plurality of plants.

16. The method of claim 11, further comprising:
installing a second frame onto the plurality of support posts at a distance further from a base of plurality of support posts than the first frame is installed thereon, so that the second frame extends in a plane that is substantially horizontal and extends substantially perpendicular to the first plurality of support posts;
installing a third plurality of support rods to the second frame along a first orientation;
installing a fourth plurality of support rods to the second frame along a second orientation;
removing the first plurality of support rods from the first frame;
removing the second plurality of support rods from the first frame;
removing the third plurality of support rods from the second frame;
removing the fourth plurality of support rods from the second frame; and
harvesting the plurality of plants.

17. A trellis apparatus to supporting a plurality of plants comprising:
a frame configured to be connected to a plurality of support posts so that the frame extends in a plane that is substantially horizontal and extends substantially perpendicular to the plurality of support posts, and wherein the frame is configured to have first plurality of support rods removeably connected thereto in a first orientation and a second plurality of support rods removeably connected thereto in a second orientation;
a first plurality of rods configured to be removeably connected to the frame in the first orientation; and
a second plurality of rods configured to be removeably connected to the frame in the second orientation.

18. The trellis apparatus of claim 17, wherein the frame has a first set of frame members and a second set of frame members, wherein the first plurality of support rods are configured to be removeably received at a first rod end and at a second rod end opposite the first rod via a first series of receiving portions on the frame, and wherein the second plurality of rods are configured to be removeably received at a first rod and end and at second rod end opposite the first rod end via a second series of receiving portions on the frame, wherein the second orientation is substantially perpendicular to the first orientation.

19. The trellis apparatus of claim 18, wherein the frame has a first set of frame members and a second set of frame members, wherein the first set of frame members are connected to the second set of frame members to form a substantially rectangular shape, and wherein the first series of receiving portions comprise a plurality of openings at substantially even intervals along the first set of frame members and the second series of receiving portions comprise a plurality of openings at substantially even intervals along the second set of frame members.

20. The trellis apparatus of claim 17, wherein the first plurality of rods and the second plurality of rods are configured to be removeably connect to the frame either by sliding the first plurality of rods and second plurality of rods into corresponding receiving portions of the frame or by placing the first plurality of rods and second plurality of rods into the corresponding receiving portions of the frame.
